(19) United States
(12) Patent Application Publication
(10) Pub. No.: US 2025/0391875 A1
(43) Pub. Date: Dec. 25, 2025

(54) CATHODE WITH ULTRA-CONDUCTIVE ADDITIVE

(71) Applicant: GM GLOBAL TECHNOLOGY OPERATIONS LLC, Detroit, MI (US)

(72) Inventors: Zhongyi Liu, Troy, MI (US); Mengyuan Chen, Madison Heights, MI (US); Chuanlong Wang, Troy, MI (US); Xiaosong Huang, Novi, MI (US); Ratandeep Singh Kukreja, Auburn Hills, MI (US)

(73) Assignee: GM GLOBAL TECHNOLOGY OPERATIONS LLC, Detroit, MI (US)

(21) Appl. No.: 18/752,496

(22) Filed: Jun. 24, 2024

(51) Int. Cl. H01M 4/62; H01M 4/02; H01M 4/04; H01M 4/131

(52) U.S. Cl. CPC H01M 4/625; H01M 4/0404; H01M 4/0435; H01M 4/131; H01M 2004/028

(57) ABSTRACT

Methods for fabricating a cathode, methods for fabricating a battery, and batteries are disclosed. A method for fabricating a cathode includes mixing a slurry including a cathode material and an ultra-conductive additive having a conductivity of at least 0.25×10⁵ siemens per centimeter (S/cm); and forming a cathode from the slurry.

### INTRODUCTION

The technical field relates generally to rechargeable electrochemical devices. More specifically, aspects of this disclosure relate to cathodes and methods for fabricating cathodes on current collectors for forming batteries.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a combustion based engine for tractive power.

A full-electric vehicle (FEV), colloquially labeled an “electric car”, is a type of electric-drive vehicle configuration that altogether omits an internal combustion engine and attendant peripheral components from the powertrain system, relying instead on a rechargeable energy storage system (RESS) and a traction motor for vehicle propulsion. Hybrid-electric vehicle (HEV) powertrains, in contrast, employ multiple sources of tractive power to propel the vehicle, most commonly operating an internal combustion engine assembly in conjunction with a battery-powered or fuel-cell-powered traction motor.

Many commercially available hybrid electric and full electric vehicles employ a rechargeable traction battery pack to store and supply the requisite power for operating the powertrain's traction motor unit(s). In order to generate tractive power with sufficient vehicle range and speed, a traction battery pack is significantly larger, more powerful, and higher in capacity (Amp-hr) than a standard 12-volt starting, lighting, and ignition (SLI) battery. Contemporary traction battery packs, for example, group stacks of battery cells (e.g., 8-16 cells/stack) into individual battery modules (e.g., 10-40 modules/pack) that are mounted onto the vehicle chassis by a battery pack housing or support tray. Stacked electrochemical battery cells may be connected in series or parallel through use of an electrical interconnect board (ICB) or front-end DC bus bar assembly. A dedicated Electronic Battery Control Module (EBCM), through collaborative operation with a Powertrain Control Module (PCM) and Traction Power Inverter Module (TPIM), regulates the opening and closing of battery pack contactors to govern operation of the battery pack.

There are four primary types of batteries that are used in electric-drive vehicles: lithium-class batteries, nickel-metal hydride batteries, ultracapacitor batteries, and lead-acid batteries.

In addition to use in electric-drive vehicles, high-energy density, electrochemical cells can be used in a variety of consumer products. Typical batteries include a first electrode, a second electrode, an electrolyte material, and a separator. One electrode serves as a positive electrode or cathode (on discharge) and another serves as a negative electrode or anode (on discharge). A stack of battery cells may be electrically connected to increase overall output. Conventional rechargeable batteries operate by reversibly passing ions back and forth between the negative electrode and the positive electrode. A separator and an electrolyte are disposed between the negative and positive electrodes. The electrolyte is suitable for conducting ions and may be in solid (e.g., solid state diffusion) or liquid form. Ions move from a cathode (positive electrode) to an anode (negative electrode) during charging of the battery, and in the opposite direction when discharging the battery.

Cathode active materials typically have low conductivity. Increasing the conductivity of a cathode may provide a battery with a higher energy density and better cycle life. Some increase to conductivity may be provided by including carbon black within the cathode to promote the transportation of electrons.

Accordingly, it would be desirable to provide method for fabricating cathodes, methods for fabricating batteries, and batteries with cathodes that have improved cathode conductivity. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for fabricating a cathode is provided and includes mixing a slurry including a cathode material and an ultra-conductive additive having a conductivity of at least 0.25×10⁵ siemens per centimeter (S/cm); and forming a cathode from the slurry.

In certain embodiments of the method, the ultra-conductive additive is selected from titanium diboride (TiB₂); niobium titanium alloy; germanium niobium alloy, and niobium nitride alloy; yttrium barium copper oxide (YBCO) ceramic; magnesium diboride ceramic; superconducting pnictides; and organic superconductors.

In certain embodiments of the method, the ultra-conductive additive is chemically inert.

In certain embodiments of the method, the ultra-conductive additive is titanium diboride (TiB₂).

In certain embodiments of the method, the cathode includes from 0.1 to 10 weight percent of the titanium diboride based on a total weight of the cathode.

In certain embodiments of the method, the cathode includes from 1 to 5 weight percent of the titanium diboride based on the total weight of the cathode.

In certain embodiments of the method, forming the cathode from the slurry includes coating a current collector with a layer of the slurry, wherein the layer has a uniform consistency of cathode material and titanium diboride.

In certain embodiments, the method further includes calendaring the layer to reduce a thickness of the layer.

In certain embodiments of the method, the ultra-conductive additive is in the form of particles having a particle thickness of from five nanometers to three micrometers.

In certain embodiments of the method, the mixing, forming, and calendaring processes are performed at a temperature of no more than 200 degrees Celsius.

In certain embodiments of the method, the slurry further includes carbon black and binder.

In certain embodiments of the method, the cathode material includes nickel (Ni), cobalt (Co), manganese (Mn), and aluminum (Al).

In certain embodiments of the method, the method includes no thermal annealing process.

In another embodiment, a method for fabricating a battery is provided and includes forming an anode; forming a cathode by coating a current collector with a slurry including a cathode material and an ultra-conductive additive having a conductivity of at least 0.25×10⁵ siemens per centimeter (S/cm); separating the anode from a cathode with a separator; and contacting the anode and the cathode with an electrolyte.

In certain embodiments of the method, the ultra-conductive additive is titanium diboride (TiB₂), and wherein the cathode includes from 0.1 to 10 weight percent of the titanium diboride based on a total weight of the cathode.

In certain embodiments of the method, the cathode includes from 0.1 to 10 weight percent of carbon black based on a total weight of the cathode.

In another embodiment, a battery is provided and includes an anode current collector; an anode active material directly contacting the anode current collector; a cathode current collector; a cathode layer directly contacting the cathode current collector, wherein the cathode layer includes a uniform mixture of a cathode active material and an ultra-conductive additive having a conductivity of at least 0.25×10⁵ siemens per centimeter (S/cm); a separator between the anode active material and the cathode layer; and an electrolyte in contact with the anode active material and the cathode layer.

In certain embodiments of the battery, the ultra-conductive additive is titanium diboride (TiB₂).

In certain embodiments of the battery, the cathode layer includes from 0.1 to 10 weight percent of titanium diboride; from 0.1 to 10 weight percent of carbon black; and at least 75 weight percent of the cathode active material, all based on a total weight of the cathode layer.

In certain embodiments of the battery, the cathode layer includes from 1 to 5 weight percent of titanium diboride; from 1 to 5 weight percent of carbon black; from 1 to 5 weight percent of a binder material; and at least 90 weight percent of the cathode active material, all based on a total weight of the cathode layer.

### DESCRIPTION OF THE DRAWINGS

The present disclosure will hereinafter be described in conjunction with the following drawing figures, wherein like numerals denote like elements, and wherein:

FIG. 1 is a schematic illustration of a representative vehicle with an electrified powertrain according to aspects of the disclosed concepts;

FIG. 2 is a schematic illustration of a representative electrochemical device in the vehicle of FIG. 1 that operates in accordance with aspects of the present disclosure;

FIG. 3 is a flowchart illustrating a method for fabricating a cathode and for fabricating a battery in accordance with aspects of the present disclosure; and

FIG. 4 is a cross-sectional schematic of a cathode formed on a current collector in accordance with aspects of the present disclosure.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

Finally, for the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

An exemplary battery, method for fabricating a cathode, and method for fabricating a battery are provided to increase the conductivity of cathodes.

Certain embodiments provide a pathway to design and fabricate a cathode with improved energy density and cycle life by incorporating ultra-conductive additives (UCA) into the cathode during the slurry mixing process. For example, titanium diboride (TiB₂) is an ultra-conductive additive that has over 1000 times higher electronic conductivity than conductive carbon black. In certain embodiments, adding a small amount of TiB₂ to the cathode material, such as from 1 to 5 weight percent (based on a total weight of the cathode), results in the cathode having higher energy density and a longer cycle life. In certain embodiments, the ultra-conductive additive added to the cathode active material is chemically inert. For example, TiB₂ is chemically inert in the battery environment.

In certain embodiments, the ultra-conductive additive is blended into a slurry of the cathode active material. Then, the slurry may be coated onto a current conductor. The layer of slurry coated on to the current conductor may be dried and/or calendared to a reduced thickness. It is noted that the layer of cathode material is substantially uniform such that the amount of ultra-conductive additive within the layer is consistent throughout the layer. This is distinguished from laminations or separated layers of materials which may present additional processing steps and cost, while obtaining lesser results.

Though not limited to such embodiments, in certain embodiments the cathode active material is nickel rich. For example, the cathode active material may be NCMA, i.e., nickel (Ni), cobalt (Co), manganese (Mn), and aluminum (Al). Blending TiB₂ with NCMA in the slurry mixing process may significantly improve electrochemical performance of the electrode formed form the slurry.

In certain embodiments, the ultra-conductive additives may include TiB₂ in the form of nanoparticles, nanofibers, nanoflakes, or other similar forms; alloys, such as niobium-titanium, germanium-niobium, and/or niobium-nitride; ceramics such as yttrium barium copper oxide (YBCO) and/or magnesium diboride; superconducting pnictides, such as fluorine-doped layered iron-based compound LaOFeAs; or organic superconductors, such as fullerenes.

In certain embodiments, a cathode is fabricated by blending the active cathode material, such as nickel rich material, with ultra-conductive additives in a slurry. For example, from 0.1 to 10 weight percent of TiB₂ may be added to the cathode slurry and thoroughly mixed at 500-3000 rpm for two to ten minutes. The mixer may include a planetary, high-speed, acoustic, static mixer, extruder and dissolver. The size of the TiB₂ particles may be from five nanometers (nm) to three micrometers (μm).

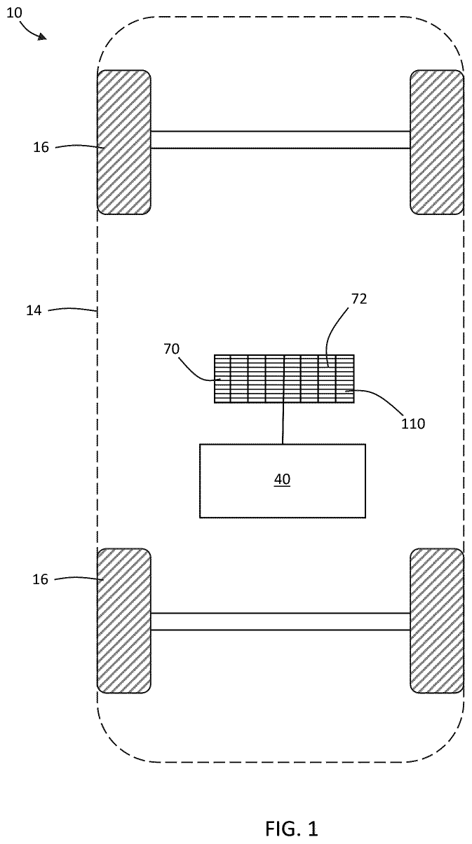

With reference to FIG. 1, certain features of a vehicle 10 are illustrated in functional block diagram form. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

The illustrated vehicle 10 is merely an exemplary application with which novel aspects of this disclosure may be practiced. In the same vein, incorporation of the present concepts into an all-electric vehicle powertrain should also be appreciated as a non-limiting implementation of disclosed features. As such, it will be understood that aspects and features of this disclosure may be applied to other powertrain architectures, may be implemented for any logically relevant type of vehicle, and may be utilized for both DC and AC-based EVCS. Moreover, only select components of the motor vehicles and battery systems are shown and described in additional detail herein. Nevertheless, the vehicles and vehicle systems discussed below may include numerous additional and alternative features, and other available peripheral components, for carrying out the various methods and functions of this disclosure.

As depicted in FIG. 1, the exemplary vehicle 10 generally includes a body 14 and wheels 16. The body 14 substantially encloses components of the vehicle 10. The wheels 16 are each rotationally coupled to the vehicle 10 near a respective corner of the body 14.

The representative vehicle 10 of FIG. 1 may be equipped with an electrified powertrain that is operable to generate and deliver tractive torque to one or more of the vehicle's road wheels 16. The powertrain is generally represented in FIG. 1 by a rechargeable energy storage system (RESS), which may be in the nature of a chassis-mounted traction battery pack 70, that is operatively connected to an electric traction motor 40. The traction battery pack 70 is generally composed of one or more battery modules 72 each having a stack of battery cells 110, such as lithium ion, lithium polymer, or nickel metal hydride battery cells of the pouch, can, or prismatic type. One or more electric machines, such as traction motor/generator units 40, draw electrical power from and, optionally, deliver electrical power to the RESS's battery pack 70. A dedicated power inverter module (PIM) may electrically connect the battery pack 70 to the motor/generator unit(s) 40 and modulate that transmission of electrical current therebetween.

The battery pack 70 may be configured such that module management, including cell sensing, thermal management, and module-to-host communications functionality, is integrated directly into each battery module 72 and performed wirelessly via a wireless-enabled cell monitoring unit (CMU). The CMU may be a microcontroller-based, printed circuit board (PCB)-mounted sensor array. Each CMU may have a GPS transceiver and RF capabilities and may be packaged on or in a battery module housing. The battery module cells 110, CMU, housing, coolant lines, busbars, etc., collectively define the module assembly.

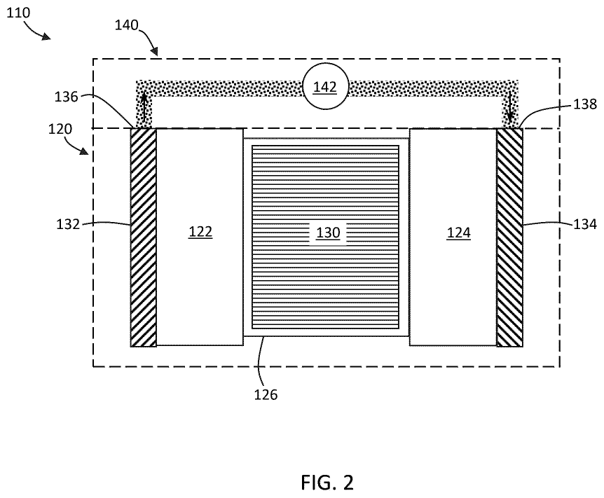

Presented in FIG. 2 is an exemplary electrochemical device in the form of a rechargeable battery 110 that powers a desired electrical load, such as vehicle 10 of FIG. 1, and offers fast charging capabilities, such as DCFC. Battery 110 includes a pair of electrically conductive electrodes, namely a first (negative or anode) working electrode 122 and a second (positive or cathode) working electrode 124, packaged inside a protective outer housing 120. In at least some configurations, the battery housing 120 may be an envelope-like pouch that is formed of aluminum foil or other suitable sheet material. Both sides of a metallic pouch may be coated with a polymeric finish to insulate the metal from the internal cell elements and from adjacent cells, if any. Alternatively, the battery housing (or “cell casing”) 120 may take on a cylindrical metal can configuration, i.e., for cylindrical battery cell configurations, or a polyhedral metal box configuration, i.e., for prismatic battery cell configurations. Reference to either working electrode 122, 124 as an “anode” or “cathode” or, for that matter, as “positive” or “negative” does not limit the electrodes 122, 124 to a particular polarity as the system polarity may change depending on whether the battery 110 is being operated in a charge mode or a discharge mode. Although FIG. 2 illustrates a single battery cell unit inserted within the battery housing 120, it should be appreciated that the housing 120 may stow therein a stack of multiple cell units (e.g., five to five thousand cells or more).

With continuing reference to FIG. 2, anode electrode 122 may be fabricated with an active anode electrode material that is capable of incorporating ions during a battery charging operation and releasing ions during a battery discharging operation. In at least some implementations, the anode electrode 122 is manufactured, in whole or in part, from a lithium metal, such as lithium-aluminum (LiAl) alloy materials with an Li/Al atomic ratio in a range from 0 at. %≤Li/Al<70 at. %, and/or aluminum alloys with Al atomic ratio>50 at. % (e.g., lithium metal is smelt). Additional examples of suitable active anode electrode materials include carbonaceous materials (e.g., graphite, hard carbon, soft carbon, etc.), silicon, silicon-carbon blended materials (silicon-graphite composite), Li₄Ti₅O₁₂, transition-metals (alloy types, e.g., Sn), metal oxide/sulfides (e.g., SnO₂, FeS and the like), etc.

Disposed inside the battery housing 120 between the two electrodes 122, 124 is a porous separator 126, which may be in the nature of a microporous or nanoporous polymeric separator. The porous separator 126 may include a non-aqueous fluid electrolyte composition and/or solid electrolyte composition, collectively designated 130, which may also be present in the negative electrode 122 and the positive electrode 124. A negative electrode current collector 132 may be positioned on or near the negative electrode 122, and a positive electrode current collector 134 may be positioned on or near the positive electrode 124. The negative electrode current collector 132 and positive electrode current collector 134 respectively collect and move free electrons to and from an external circuit 140. An interruptible external circuit 140 with a load 142 connects to the negative electrode 122, through its respective current collector 132 and electrode tab 136, and to the positive electrode 124, through its respective current collector 134 and electrode tab 138. Current collectors 132 and 134 may be formed from aluminum, copper or another suitable material. Separator 126 may be a sheet-like structure that is composed of a porous polyolefin membrane, e.g., with a porosity of about 35% to 65% and a thickness of approximately 25-30 microns. Electrically non-conductive ceramic particles (e.g., silica) may be coated onto the porous membrane surfaces of the separators 126.

The porous separator 126 may operate as both an electrical insulator and a mechanical support structure by being sandwiched between the two electrodes 122, 124 to prevent the electrodes from physically contacting each other and, thus, the occurrence of a short circuit. In addition to providing a physical barrier between the electrodes 122, 124, the porous separator 126 may provide a minimal resistance path for internal passage of ions (and related anions) during cycling of the ions to facilitate functioning of the battery 110. For some optional configurations, the porous separator 126 may be a microporous polymeric separator including a polyolefin. The polyolefin may be a homopolymer, which is derived from a single monomer constituent, or a heteropolymer, which is derived from more than one monomer constituent, and may be either linear or branched. In a solid-state battery, the role of the separator may be partially/fully provided by a solid electrolyte layer.

Operating as a rechargeable energy storage system (RESS), battery 110 generates electric current that is transmitted to one or more loads 142 operatively connected to the external circuit 140. While the load 142 may be any number of electrically powered devices, a few non-limiting examples of power-consuming load devices include an electric motor for a hybrid or full-electric vehicle, a laptop or tablet computer, a cellular smartphone, cordless power tools and appliances, portable power stations, etc. The battery 110 may include a variety of other components that, while not depicted herein for simplicity and brevity, are nonetheless readily available. For instance, the battery 110 may include one or more gaskets, terminal caps, tabs, battery terminals, and other commercially available components or materials that may be situated on or in the battery 110. Moreover, the size and shape and operating characteristics of the battery 110 may vary depending on the particular application for which it is designed.

Cathode electrode 124 may be fabricated with an active cathode electrode material that is capable of supplying ions during a battery charging operation and incorporating ions during a battery discharging operation. The cathode electrode 124 material may include, for instance, lithium transition metal oxide, phosphate, or silicate, such as LiMO₂ (M=Co, Ni, Mn, or combinations thereof); LiM₂O₄ (M=Mn, Ti, or combinations thereof), LiMPO₄ (M=Fe, Mn, Co, or combinations thereof), and LiMₓM′₂₋ₓO₄ (M, M′=Mn or Ni). Additional examples of suitable active cathode electrode materials include lithium nickel cobalt manganese oxide (NCM), lithium nickel cobalt aluminum oxide (NCA), lithium nickel cobalt manganese aluminum oxide (NCMA), and other lithium transition-metal oxides.

In embodiments herein, the second (positive or cathode) working electrode 124 also includes an ultra-conductive additive. For purposes herein, an “ultra-conductive additive” has a conductivity of at least 0.25×10⁵ siemens per centimeter (S/cm). In certain embodiments, the ultra-conductive additive has a conductivity of at least 0.3×10⁵ S/cm, at least 0.4×10⁵ S/cm, at least 0.45×10⁵ S/cm, at least 0.5×10⁵ S/cm, at least 0.51×10⁵ S/cm, at least 0.52×10⁵ S/cm, at least 0.53×10⁵ S/cm, at least 0.54×10⁵ S/cm, at least 0.55×10⁵ S/cm, at least 0.56×10⁵ S/cm, at least 0.57×10⁵ S/cm, at least 0.58×10⁵ S/cm, at least 0.59×10⁵ S/cm, at least 0.6×10⁵ S/cm, at least 0.7×10⁵ S/cm, at least 0.8×10⁵ S/cm, at least 0.9×10⁵ S/cm, at least 1.0×10⁵ S/cm, or at least 1.1×10⁵ S/cm. In certain embodiments, the ultra-conductive additive has a conductivity of at most 1.0×10⁶ S/cm.

The ultra-conductive additive may be selected from titanium diboride (TiB₂) such as in the form of nanoparticles, nanofibers, nanoflakes, or other suitable forms; alloys, such as niobium-titanium, germanium-niobium, and/or niobium-nitride; ceramics such as yttrium barium copper oxide (YBCO) and/or magnesium diboride; superconducting pnictides, such as fluorine-doped layered iron-based compound LaOFeAs; or organic superconductors, such as fullerenes. It is noted that titanium diboride (TiB₂) has an electric conductivity of from 0.599×10⁵ to 1.11×10⁵ S/cm.

In certain embodiments, the ultra-conductive additive is chemically inert within the environment of the battery 110. As used herein, “chemically inert” means that the species will not undergo a chemical reaction upon exposure of the species to other compounds, chemicals, or solutions in the battery 110, or upon exposure to electromagnetic irradiation or temperatures encountered during typical operation of the battery 110.

In certain embodiments, the ultra-conductive additive is titanium diboride (TiB₂) in the form of particles that have a particle dimension or thickness of from five nanometers to three micrometers.

In certain embodiments, the cathode electrode 124 includes from 0.1 to 10 weight percent of the ultra-conductive additive based on a total weight of the cathode electrode 124. For example, the cathode electrode 124 may include at least 0.1 weight percent of the ultra-conductive additive based on a total weight of the cathode electrode 124, such at least 0.2 weight percent; at least 0.3 weight percent; at least 0.4 weight percent; at least 0.5 weight percent; at least 0.6 weight percent; at least 0.7 weight percent; at least 0.8 weight percent; at least 0.9 weight percent; at least 1.0 weight percent; at least 1.1 weight percent; at least 1.2 weight percent; at least 1.3 weight percent; at least 1.4 weight percent; at least 1.5 weight percent; at least 1.6 weight percent; at least 1.7 weight percent; at least 1.8 weight percent; at least 1.9 weight percent; at least 2.0 weight percent; at least 2.1 weight percent; at least 2.2 weight percent; at least 2.3 weight percent; at least 2.4 weight percent; at least 2.5 weight percent; at least 2.6 weight percent; at least 2.7 weight percent; at least 2.8 weight percent; at least 2.9 weight percent; at least 3.0 weight percent; at least 3.2 weight percent; at least 3.4 weight percent; at least 3.6 weight percent; at least 3.8 weight percent; at least 4.0 weight percent; at least 4.2 weight percent; at least 4.4 weight percent; at least 4.6 weight percent; at least 4.8 weight percent; at least 5.0 weight percent; at least 5.2 weight percent; at least 5.4 weight percent; at least 5.6 weight percent; at least 5.8 weight percent; at least 6.0 weight percent; at least 6.2 weight percent; at least 6.4 weight percent; at least 6.6 weight percent; at least 6.8 weight percent; at least 7.0 weight percent; at least 7.2 weight percent; at least 7.4 weight percent; at least 7.6 weight percent; at least 7.8 weight percent; at least 8.0 weight percent; at least 8.2 weight percent; at least 8.4 weight percent; at least 8.6 weight percent; at least 8.8 weight percent; at least 9.0 weight percent; at least 9.2 weight percent; at least 9.4 weight percent; at least 9.6 weight percent; or at least 9.8 weight percent of the ultra-conductive additive based on a total weight of the cathode electrode 124.

In certain embodiments, the cathode electrode 124 includes at most 0.3 weight percent; at most 0.4 weight percent; at most 0.5 weight percent; at most 0.6 weight percent; at most 0.7 weight percent; at most 0.8 weight percent; at most 0.9 weight percent; at most 1.0 weight percent; at most 1.1 weight percent; at most 1.2 weight percent; at most 1.3 weight percent; at most 1.4 weight percent; at most 1.5 weight percent; at most 1.6 weight percent; at most 1.7 weight percent; at most 1.8 weight percent; at most 1.9 weight percent; at most 2.0 weight percent; at most 2.1 weight percent; at most 2.2 weight percent; at most 2.3 weight percent; at most 2.4 weight percent; at most 2.5 weight percent; at most 2.6 weight percent; at most 2.7 weight percent; at most 2.8 weight percent; at most 2.9 weight percent; at most 3.0 weight percent; at most 3.2 weight percent; at most 3.4 weight percent; at most 3.6 weight percent; at most 3.8 weight percent; at most 4.0 weight percent; at most 4.2 weight percent; at most 4.4 weight percent; at most 4.6 weight percent; at most 4.8 weight percent; at most 5.0 weight percent; at most 5.2 weight percent; at most 5.4 weight percent; at most 5.6 weight percent; at most 5.8 weight percent; at most 6.0 weight percent; at most 6.2 weight percent; at most 6.4 weight percent; at most 6.6 weight percent; at most 6.8 weight percent; at most 7.0 weight percent; at most 7.2 weight percent; at most 7.4 weight percent; at most 7.6 weight percent; at most 7.8 weight percent; at most 8.0 weight percent; at most 8.2 weight percent; at most 8.4 weight percent; at most 8.6 weight percent; at most 8.8 weight percent; at most 9.0 weight percent; at most 9.2 weight percent; at most 9.4 weight percent; at most 9.6 weight percent; at most 9.8 weight percent; or at most 10 weight percent of the ultra-conductive additive based on a total weight of the cathode electrode 124. For example, the cathode electrode 124 may include from 1 to 5 weight percent of the ultra-conductive additive based on the total weight of the cathode electrode 124.

In certain embodiments, cathode electrode 124 includes, in addition to the active cathode electrode material and the ultra-conductive additive, carbon black, and a binder material.

In certain embodiments, the binder material is selected from styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylenic/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, carboxymethyl cellulose, hydroxypropyl cellulose, cellulose acetate, cellulose acetate butyrate, cellulose acetate propionate, cyanoethylcellulose, cyanoethylsucrose, polyester, polyamide, polyether, polyimide, polycarboxylate, polycarboxylic acid, polyacrylic acid, polyacrylate, polymethacrylic acid, polymethacrylate, polyacrylamide, polyurethane, fluorinated polymer, chlorinated polymer, polyvinylidene fluoride, poly(vinylidene fluoride)-hexafluoropropene, and combinations thereof.

In certain embodiments, the cathode electrode 124 includes from 0.1 to 10 weight percent of carbon black based on a total weight of the cathode electrode 124. For example, cathode electrode 124 may include at least 0.1, at least 0.25, at least 0.5, at least 0.75, at least 1, at least 1.5, at least 2, at least 2.5, at least 3, at least 4, at least 5, at least 6, at least 7, at least 8, or at least 9 weight percent of carbon black based on a total weight of the cathode electrode 124. Further, cathode electrode 124 may include at most 0.25, at most 0.5, at most 0.75, at most 1, at most 1.5, at most 2, at most 2.5, at most 3, at most 4, at most 5, at most 6, at most 7, at most 8, at most 9, or at most 10 weight percent of carbon black based on a total weight of the cathode electrode 124.

In certain embodiments, the cathode electrode 124 includes from 70 to 99 weight percent of the active cathode electrode material. For example, cathode electrode 124 may include at least 70, at least 75, at least 80, at least 85, at least 90, or at least 95 weight percent of active cathode electrode material based on a total weight of the cathode electrode 124. Further, cathode electrode 124 may include at most 75, at most 80, at most 85, at most 90, at most 95, or at most 99 weight percent of active cathode electrode material based on a total weight of the cathode electrode 124.

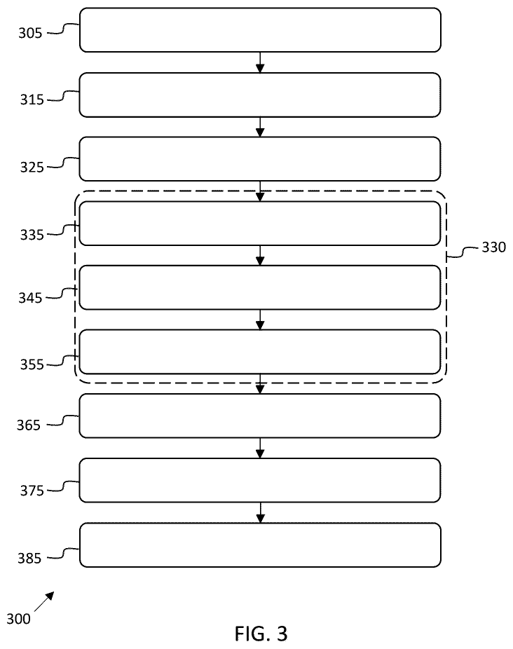

FIG. 3 is a flow chart illustrating a method 300 for fabricating a cathode. Method 300 includes, at 305, forming a slurry including active cathode material. The slurry may further include carbon black, a binder material, and solvent.

At 315, method 300 includes adding an ultra-conductive additive to the slurry. At 325, method 300 includes mixing the slurry. For example, after adding the ultra-conductive additive, the slurry may be mixed at a rate of from 500 to 3000 rpm for a duration of from two to ten minutes. The mixer may include a planetary, high-speed, acoustic, static mixer, extruder and dissolver. After mixing, the slurry is a homogeneous mixture, i.e., the slurry has a substantially homogenous consistency. In other words, the ultra-conductive additive is dispersed evenly throughout the slurry.

After forming a homogenous slurry, method 300 continues at 335 with applying a layer of the slurry to a conductive collector 134. The layer of slurry forms the cathode electrode 124.

At 345, method 300 dries the layer of slurry. While drying the layer of slurry, the temperature of the slurry is maintained at no higher than 200 degrees Celsius.

At 355, method 300 calendars the layer of slurry. While calendaring the layer of slurry, the temperature of the slurry is maintained at a temperature of no higher than 200 degrees Celsius. After calendaring the layer of slurry, processing of the layer is complete and the cathode electrode 124 is formed. Thus, method 300 may be considered to include at 330, forming the cathode from the slurry, which incorporates applying the layer, drying the layer, and calendaring the layer of operations 335, 345, and 355.

After forming the cathode electrode 124, method 300 continues at 365 with assembling the battery 110 and cells thereof. For example, cathode electrode 124 and collector 134 may be positioned in battery housing 120 and spaced apart from anode electrode 122 and current collector 132 by porous separator 126 and in contact with electrolyte composition 130.

Thereafter, method 300 may include, at 375, performed a cycle of charge and discharge processes. Thereafter, method 300 may include operating a device, such as vehicle 10, with power from the battery.

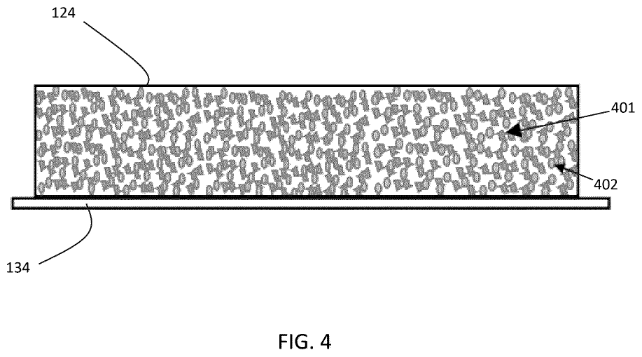

FIG. 4 provides a cross-sectional schematic illustrating a cathode electrode 124 on a current collector 134. As shown, cathode electrode 124 includes cathode material particles 401 and ultra-conductive additive particles 402. Other particles including carbon black and binder material may be present in the cathode electrode 124.

As shown, the cathode electrode 124 has a homogenous consistency. Specifically, a same ratio of ultra-conductive additive particles 402 are located in each region of the cathode electrode 124. In other words, no region of the cathode electrode 124 has fewer ultra-conductive additive particles 402 and no region of the cathode electrode 124 has a greater number of ultra-conductive additive particles 402.

Accordingly, embodiments herein provide for increasing the electrical conductivity of a cathode by incorporating an ultra-conductive additive into the slurry that forms the cathode.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for fabricating a cathode, the method comprising:
mixing a slurry including a cathode material and an ultra-conductive additive having a conductivity of at least 0.25×10⁵ siemens per centimeter (S/cm); and
forming the cathode from the slurry.

2. The method of claim 1, wherein the ultra-conductive additive is selected from titanium diboride (TiB₂); niobium titanium alloy; germanium niobium alloy, and niobium nitride alloy; yttrium barium copper oxide (YBCO) ceramic; magnesium diboride ceramic; superconducting pnictides; and organic superconductors.

3. The method of claim 2, wherein the ultra-conductive additive is chemically inert.

4. The method of claim 1, wherein the ultra-conductive additive is titanium diboride (TiB₂).

5. The method of claim 4, wherein the cathode comprises from 0.1 to 10 weight percent of the titanium diboride based on a total weight of the cathode.

6. The method of claim 4, wherein the cathode comprises from 1 to 5 weight percent of the titanium diboride based on a total weight of the cathode.

7. The method of claim 1, wherein forming the cathode from the slurry comprises coating a current collector with a layer of the slurry, wherein the layer has a uniform consistency of the cathode material and titanium diboride.

8. The method of claim 7, further comprising calendaring the layer to reduce a thickness of the layer.

9. The method of claim 8, wherein the ultra-conductive additive is in the form of particles having a particle thickness of from five nanometers to three micrometers.

10. The method of claim 8, wherein the mixing, forming, and calendaring processes are performed at a temperature of no more than 200 degrees Celsius.

11. The method of claim 1, wherein the slurry further comprises:
carbon black; and
binder.

12. The method of claim 1, wherein the cathode material comprises nickel (Ni), cobalt (Co), manganese (Mn), and aluminum (Al).

13. The method of claim 1, wherein the method comprises no thermal annealing process.

14. A method for fabricating a battery, the method comprising:
forming an anode;
forming a cathode by coating a current collector with a slurry including a cathode material and an ultra-conductive additive having a conductivity of at least 0.25×10⁵ siemens per centimeter (S/cm);
separating the anode from the cathode with a separator; and
contacting the anode and the cathode with an electrolyte.

15. The method of claim 14, wherein the ultra-conductive additive is titanium diboride (TiB₂), and wherein the cathode comprises from 0.1 to 10 weight percent of the titanium diboride based on a total weight of the cathode.

16. The method of claim 15, wherein the cathode comprises from 0.1 to 10 weight percent of carbon black based on a total weight of the cathode.

17. A battery comprising:
an anode current collector;
an anode active material directly contacting the anode current collector;
a cathode current collector;
a cathode layer directly contacting the cathode current collector, wherein the cathode layer comprises a uniform mixture of a cathode active material and an ultra-conductive additive having a conductivity of at least 0.25×10⁵ siemens per centimeter (S/cm);
a separator between the anode active material and the cathode layer; and
an electrolyte in contact with the anode active material and the cathode layer.

18. The battery of claim 17, wherein the ultra-conductive additive is titanium diboride (TiB₂).

19. The battery of claim 18, wherein the cathode layer comprises:
from 0.1 to 10 weight percent of titanium diboride;
from 0.1 to 10 weight percent of carbon black; and
at least 75 weight percent of the cathode active material, all based on a total weight of the cathode layer.

20. The battery of claim 19, wherein the cathode layer comprises:
from 1 to 5 weight percent of titanium diboride;
from 1 to 5 weight percent of carbon black;
from 1 to 5 weight percent of a binder material; and
and at least 90 weight percent of the cathode active material, all based on a total weight of the cathode layer.
